(19) United States
(12) Patent Application Publication
(10) Pub. No.: US 2019/0169046 A1
(43) Pub. Date: Jun. 6, 2019

(54) Multi-Stage Degassing in Aquaculture Systems

(71) Applicant: Atlantic Sapphire IP, L.L.C., Miami, FL (US)

(72) Inventor: Thue Holm, Vejle (DK)

(21) Appl. No.: 15/829,817

(22) Filed: Dec. 1, 2017

(51) Int. Cl. C02F 1/20; B01D 19/00; A01K 63/04

(52) U.S. Cl. CPC C02F 1/20; B01D 19/0031; C02F 2101/10; A01K 63/047; A01K 63/045

(57) ABSTRACT

Multi-stage degassing for aquaculture systems are disclosed herein. An example system includes an aquaculture vessel outputting water with carbon dioxide content at a first concentration, a drum filter assembly, a biofilter assembly, a trickling assembly; and wherein the water is directed serially and sequentially through each of the drum filter assembly, the biofilter assembly, and the trickling assembly to strip the carbon dioxide content out of the water.

### FIELD OF THE INVENTION

The present technology pertains to aquaculture, and more specifically, but not by limitation to degassing of water within an aquaculture system. Methods and systems for degassing can involve sequentially removing undesired gasses such as carbon dioxide in various stages.

### SUMMARY

Various embodiments of the present disclosure are directed to a system comprising an aquaculture vessel outputting water with carbon dioxide content at a first concentration; a drum filter assembly; a biofilter assembly; a trickling assembly; and wherein the water is directed serially and sequentially through each of the drum filter assembly, the biofilter assembly, and the trickling assembly to strip the carbon dioxide content out of the water so that the carbon dioxide content is at a second concentration that is less than the first concentration.

Various embodiments of the present disclosure are directed to a method comprising outputting water from an aquaculture vessel, the water has a carbon dioxide content created by fish in the aquaculture vessel; directing the water through a first carbon dioxide stripping assembly to remove a portion of the carbon dioxide content; directing the water from the first carbon dioxide stripping assembly through a second carbon dioxide stripping assembly to remove a second portion of the carbon dioxide content; and directing the water from the first carbon dioxide stripping assembly through a third carbon dioxide stripping assembly to remove a third portion of the carbon dioxide content.

Various embodiments of the present disclosure are directed to a system comprising an aquaculture vessel outputting water with carbon dioxide content; and a plurality of degassing assemblies connected in series, wherein each of the plurality of degassing assemblies removes at least a portion of the carbon dioxide content, wherein at least one of the plurality of degassing assemblies is in fluid communication with the aquaculture vessel.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIGS. 1 and 2 collectively illustrate a schematic diagram of an example multi-stage degassing assembly constructed in accordance with the present disclosure.

FIG. 3 is a flowchart of an example method of multi-stage or sequential degassing performed in accordance with the present disclosure.

### DETAILED DESCRIPTION

The present disclosure is now described more fully with reference to the accompanying drawings, in which example embodiments of the present disclosure are shown. The present disclosure may, however, be embodied in many different forms and should not be construed as necessarily being limited to the example embodiments set forth herein. Rather, these example embodiments are provided so that the disclosure is thorough and complete, and fully conveys the concepts of the present disclosure to those skilled in the art. Also, features described with respect to certain example embodiments may be combined in and/or with various other example embodiments. Different aspects and/or elements of example embodiments, as disclosed herein, may be combined in a similar manner. Further, at least some example embodiments may individually and/or collectively be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity, at least as described herein, in any manner, irrespective of the at least one entity have any relationship to the subject matter of the present disclosure.

Generally described, the present disclosure describes degassing systems that are used to degas water in an aquaculture system. In one or more embodiments, carbon dioxide will accumulate in water within an aquaculture system, and specifically in an aquaculture vessel that retains fish or other biological entities. The natural reaction that removes carbon dioxide is slow, especially in seawater and/or similar fluids that have a relatively high pH level.

The systems and methods disclosed herein remove carbon dioxide from seawater or other similar fluids in an aquaculture system using a plurality of stages. In some embodiments, each stage is facilitated by a specific and unique assembly. A plurality of these assemblies are arranged in a serial manner, where seawater is sequentially processed through each of the plurality of these assemblies. Each of the plurality of these assemblies will strip or remove a portion of the carbon dioxide from the seawater such that a concentration of carbon dioxide in the seawater is progressively reduced as the seawater migrates through the assemblies.

These and other advantages of the present disclosure are provided in greater detail herein with reference to the collective drawings.

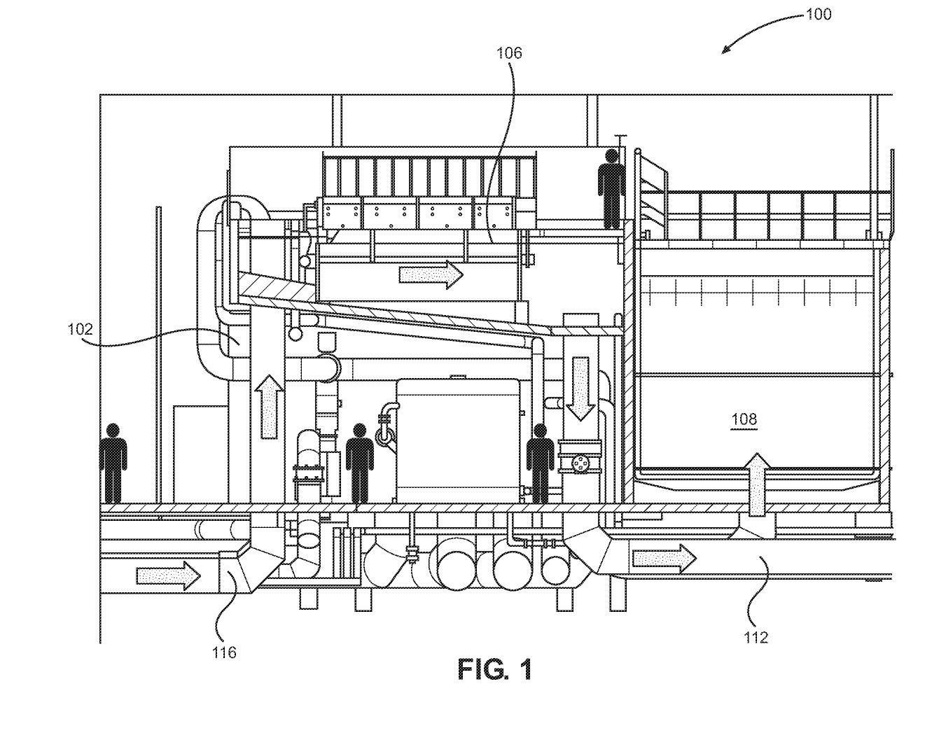

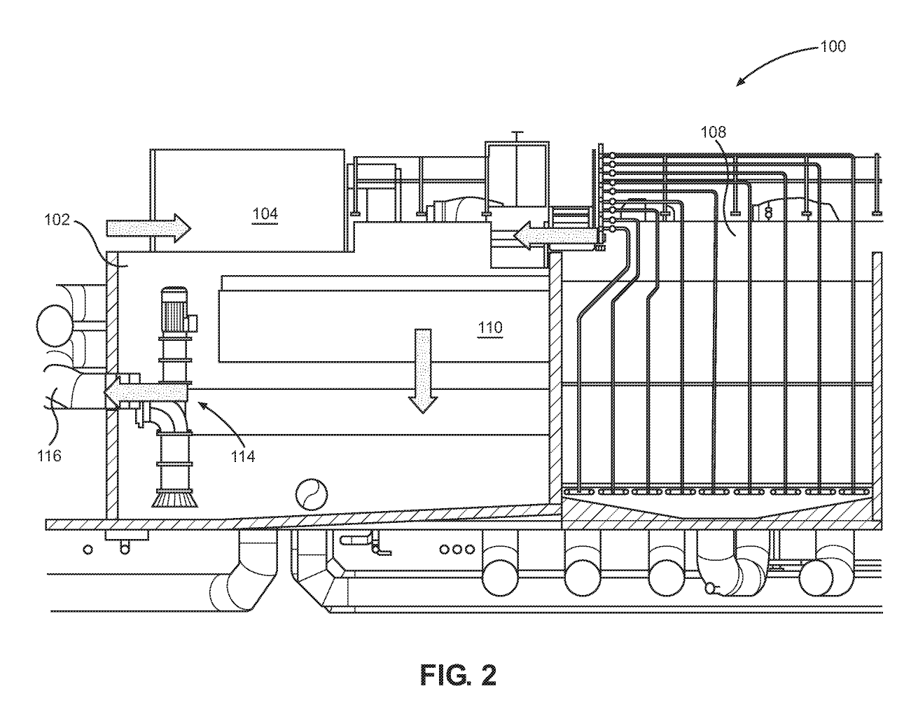

FIGS. 1 and 2 collectively illustrate an example multi-stage degassing system that is integrated into an aquaculture system. In some embodiments, the aquaculture system 100 comprises an aquaculture vessel 102 that receives and retains seawater and biological creatures such as fish. In various embodiments, the fish include salmon.

The degassing system comprises a header tank assembly 104, a drum filter assembly 106, a biofilter assembly 108, and a trickling assembly 110. In general, the drum filter assembly 106, biofilter assembly 108, and trickling assembly 110 are collectively referred to as a plurality of degassing assemblies.

The seawater that is output by the aquaculture vessel 102 has a given concentration of carbon dioxide. A portion of the carbon dioxide is removed by each of the assemblies above. When returned after processing, the seawater has a carbon dioxide concentration that is less than the concentration when initially output from the aquaculture vessel 102.

In some embodiments, seawater in the aquaculture vessel 102 is initially pumped into the drum filter assembly 106. As the seawater is processed in the drum filter assembly 106, a first portion of the concentration of carbon dioxide in the seawater is removed. In various embodiments, the seawater will remain within the drum filter assembly 106 for a given period of time, referred to as a first period of time. Also, while a drum filter has been disclosed, it will be understood that the drum filter assembly 106 can be replaced with any other non-biological filter system that would be known to one of skill in the art. In some embodiments, the seawater remains in the drum filter assembly 106 for approximately one minute.

After processing the seawater at the drum filter assembly 106, the partially degassed seawater is pumped into the biofilter assembly 108 through a pipe 112. In some embodiments, the pipe extends into a bottom surface of the biofilter assembly 108. The partially degassed seawater is then processed by the biofilter assembly 108 to remove a second portion of the concentration of carbon dioxide in the seawater. In various embodiments, the seawater will remain within the biofilter assembly 108 for a given period of time, referred to as a second period of time. In some embodiments, the seawater remains in the biofilter assembly 108 for approximately six minutes. In some embodiments, air is diffused into the seawater at a particular depth that is selected according to design requirements.

The further degassed seawater is then pumped or otherwise transferred to a trickling assembly 110. As the seawater is processed in the trickling assembly 110, a third portion of the concentration of carbon dioxide in the seawater is removed. In various embodiments, the seawater will remain within the trickling assembly 110 for a given period of time, referred to as a third period of time. 30 seconds. In some embodiments, the seawater remains in the trickling assembly 110 for approximately thirty seconds.

The length of each of the first, second, and third periods of time, either individually or collectively, may be dictated by the initial concentration of carbon dioxide within the seawater. In some embodiments, the total transit time through the assemblies is approximately seven to eight minutes, inclusive.

For context, the carbon dioxide that is not ionized and bound to seawater molecules will freely disassociate or strip from the seawater efficiently. On the other hand, carbon dioxide that is ionized and bound to the seawater molecules requires time before it can be stripped. The transit time through the three-stage degassing assembly disclosed above allows for a reaction time that is sufficient to allow for degassing to initiate and progress. To be sure, once degassing of seawater begins, the degassing process will accelerate, but in order to achieve this accelerated degassing state the seawater is sequentially processed. Also, diversity in stripping or degassing techniques created through the use of a plurality of degassing assemblies as described above.

Additionally, sequential order of drum filter assembly 106, biofilter assembly 108, and trickling assembly have been disclosed, these assemblies can be arranged in any desired order.

After the seawater has been degassed in this sequential process, the degassed the concentration of carbon dioxide in the seawater is substantially reduced. In various embodiments, a desired reduced concentration of carbon dioxide is approximately 2.4 mg/liter. In various embodiments an upper range or threshold of carbon dioxide concentration is approximately 12 mg/liter. In various embodiments, a carbon dioxide monitor positioned in the flow of seawater in the aquaculture system, such as the vessel can monitor carbon dioxide concentration. When the carbon dioxide concentration is within a range of two mg/liter and 12 mg/liter, inclusive, a control system can open a valve that is in fluid communication with the vessel and the drum filter assembly 106 to allow for seawater to transfer through the assemblies for degassing.

After degassing, the seawater exits the trickling assembly 110 and is pumped back to the aquaculture vessel 102 using propeller pumps 114 or other means that would be known to one of ordinary skill in the art with the present disclosure before them. In some embodiments, the degassed seawater is directed through the return pipe 116 that is in fluid communication with the aquaculture vessel 102.

In some embodiments, the degassed seawater is transmitted into the header tank assembly 104 prior to reintroduction into the aquaculture vessel 102. The header tank assembly 104 can comprise a vessel that receives degassed seawater from a last of the plurality of degassing assemblies disclosed above. Seawater can be transferred back into the aquaculture vessel 102 from the header tank assembly 104 using any method that would be known to one of ordinary skill in the art with the present disclosure before them.

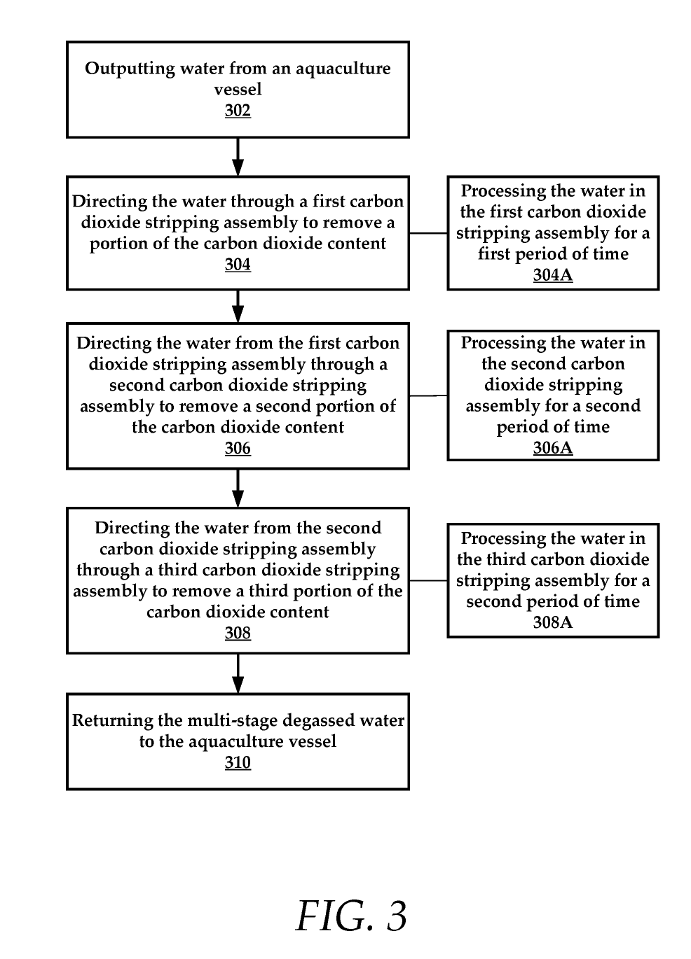

FIG. 3 is a flowchart of an example multi-stage degassing process where carbon dioxide is stripped from seawater in three or more degassing assemblies. As noted above, these degassing assemblies are connected in series such that the seawater flows through each of the degassing assemblies in a particular sequence. In particular the water that is processed in this method includes seawater, but can include any fluid used in an aquaculture process.

In some embodiments, the method includes a step 302 of outputting water from an aquaculture vessel. It will be understood that the water has a carbon dioxide content created by fish in the aquaculture vessel. As the fish grow in the aquaculture vessel, fish byproducts and biological processes will raise the content of carbon dioxide in the seawater within the aquaculture vessel. If the concentration of carbon dioxide is too great (measured in parts per million), the fish will become hypoxic and die. As noted above, when carbon dioxide is bound within seawater, the process for stripping or degassing the carbon dioxide requires a specified period of time based on concentration.

In order to begin multi-stage degassing, the method can include a first degassing stage that comprises a step 304 of directing the water through a first carbon dioxide stripping assembly to remove a portion of the carbon dioxide content. As noted above, the water is processed within, for example, a drum filter assembly for a period of time.

Next, the method includes a second degassing stage that comprises a step 306 of directing the water from the first carbon dioxide stripping assembly through a second carbon dioxide stripping assembly to remove a second portion of the carbon dioxide content. This second carbon dioxide stripping assembly can comprise a biofilter assembly.

In one or more embodiments, the method includes a third degassing stage that comprises a step 308 of directing the water from the first carbon dioxide stripping assembly through a third carbon dioxide stripping assembly to remove a third portion of the carbon dioxide content.

In various embodiments, the method can include a step 304A of processing the water in the drum filter assembly for a first period of time, as well as a step 306A of processing the water exiting the drum filter assembly in the biofilter assembly for a second period of time. In some embodiments, the method includes a step 308A of processing the water exiting the biofilter assembly in the trickling assembly for a third period of time. The collective period of time spent degassing the seawater depends on the initial concentration of carbon dioxide in the seawater that exits the aquaculture vessel in step 302.

After the water has progressed through the plurality of degassing/stripping assemblies disclosed, the method can include a step 310 of returning the multi-stage degassed water to the aquaculture vessel.

In some embodiments, the method includes an optional step of returning the water exiting the third carbon dioxide stripping assembly to a header tank assembly through a propeller pump. It will be understood that holding the water in the header tank can allow for yet further degassing when the water is retained in the header tank for a period of time (e.g., a fourth period of time).

As noted above, in some embodiments, the drum filter assembly, the biofilter assembly, and the trickling assembly are in serial arrangement with one another such that the water flows through sequentially. The order of arrangement of these assemblies can be selected based on design preference.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A system, comprising:
an aquaculture vessel outputting water with carbon dioxide content at a first concentration;
a drum filter assembly;
a biofilter assembly;
a trickling assembly; and
wherein the water is directed serially and sequentially through each of the drum filter assembly, the biofilter assembly, and the trickling assembly to strip the carbon dioxide content out of the water so that the carbon dioxide content is reduced.

2. The system according to claim 1, wherein the water is first directed through the drum filter assembly to reduce the carbon dioxide content to a second concentration that is less than the first concentration, then through the biofilter assembly to reduce the carbon dioxide content to a third concentration that is less than the second concentration, and then the trickling assembly to reduce the carbon dioxide content to a fourth concentration that is less than the third concentration.

3. The system according to claim 1, wherein the water exiting the trickling assembly is returned to the aquaculture vessel through a propeller pump.

4. The system according to claim 1, wherein the drum filter assembly, the biofilter assembly, and the trickling assembly are in serial arrangement with one another such that the water flows through sequentially.

5. The system according to claim 4, wherein the water persists in each of the drum filter assembly, the biofilter assembly, and the trickling assembly for a period of time.

6. The system according to claim 5, wherein the water enters a header tank prior to flowing back into the aquaculture vessel.

7. The system according to claim 1, wherein the water is seawater.

8. A method, comprising:
outputting water from an aquaculture vessel, the water has a carbon dioxide content created by fish in the aquaculture vessel;
directing the water through a first carbon dioxide stripping assembly to remove a portion of the carbon dioxide content;
directing the water from the first carbon dioxide stripping assembly through a second carbon dioxide stripping assembly to remove a second portion of the carbon dioxide content; and
directing the water from the second carbon dioxide stripping assembly through a third carbon dioxide stripping assembly to remove a third portion of the carbon dioxide content.

9. The method according to claim 8, wherein the water is seawater.

10. The method according to claim 8, further comprising returning the water exiting the third carbon dioxide stripping assembly to a header tank assembly through a propeller pump.

11. The method according to claim 8, wherein the first carbon dioxide stripping assembly, the second carbon dioxide stripping assembly, and the third carbon dioxide stripping assembly are in serial arrangement with one another such that the water flows through sequentially.

12. The method according to claim 11, further comprising processing the water in the first carbon dioxide stripping assembly for a first period of time, processing the water exiting the first carbon dioxide stripping assembly in the second carbon dioxide stripping assembly for a second period of time, and processing the water exiting the second carbon dioxide stripping assembly in the third carbon dioxide stripping assembly for a third period of time.

13. The method according to claim 12, further comprising holding the water exiting the third carbon dioxide stripping assembly in a header tank assembly for a fourth period of time.

14. The method according to claim 8, further comprising directing the water in a header tank into the aquaculture vessel after degassing.

15. A system, comprising:
an aquaculture vessel outputting water with carbon dioxide content; and
a plurality of degassing assemblies connected in series, wherein each of the plurality of degassing assemblies removes at least a portion of the carbon dioxide content, wherein at least one of the plurality of degassing assemblies is in fluid communication with the aquaculture vessel.

16. The system according to claim 15, wherein the plurality of degassing assemblies comprise any of a drumfilter assembly, a biofilter assembly, a trickling assembly, and combinations or permutations thereof.

17. The system according to claim 16, wherein the drumfilter assembly, the biofilter assembly, and the trickling assembly are in serial arrangement with one another such that each removes at least a portion of the carbon dioxide content from the water.
